(19) United States
(12) Patent Application Publication
(10) Pub. No.: US 2021/0191349 A1
(43) Pub. Date: Jun. 24, 2021

(54) BUILDING AUTOMATION SYSTEM EMERGENCY RESPONSE CONTROL HANDOFF

(71) Applicant: SCHNEIDER ELECTRIC BUILDINGS, LLC, Rockford, IL (US)

(72) Inventor: Kenneth Craig Nemeth, Quebec (CA)

(73) Assignee: SCHNEIDER ELECTRIC BUILDINGS, LLC, Rockford, IL (US)

(21) Appl. No.: 17/124,646

(22) Filed: Dec. 17, 2020

Related U.S. Application Data
(60) Provisional application No. 62/950,413, filed on Dec. 19, 2019.

(51) Int. Cl. G05B 15/02

(52) U.S. Cl. CPC G05B 15/02

(57) ABSTRACT

A server associated with a building automation system of a building, determines an occurrence of an emergency in the building, based on detection of the emergency by sensors distributed in the building. The server transmits to a remote emergency service, an alert of the detected emergency. In response, the server receives from the remote emergency service, an authorized login to temporarily transfer to the remote emergency service, control of the building automation system to respond to the detected emergency. In response to the authorized login, the server transfers the control to the remote emergency service, and causes the remote emergency service to transmit a command to devices in the building automation system. When the command is received by the devices, it modifies or alters operation of the devices. After the detected emergency has been resolved, the server disables the temporary transfer of control by the remote emergency service.

### CROSS REFERENCE TO RELATED APPLICATIONS

This application claims the benefit of and priority to U.S. Provisional Application No. 62/950,413, filed on Dec. 19, 2019 under 35 U.S.C. 119(e), which application is incorporated by reference herein in its entirety.

### TECHNICAL FIELD

The present disclosure relates to integrating emergency detection systems into building automation systems, and more particularly to temporarily transferring control of the building control system to an authorized remote emergency service.

### BACKGROUND

In the event of an emergency arising in a building, such as an office building, a school building, a theater, or the like, emergency responders or remote emergency services typically need to access building plans and locations of electrical panels, and the like, to assess and manage the emergency situation. Possible building emergencies may include fire, explosion, hazardous materials release, natural gas leaks, plumbing failure or flooding, power failure, elevator failure, and medical emergencies. Other types of emergencies perpetrated by actors may include active shooter, bomb threats and suspicious mail, demonstrations or protests, and workplace violence. Any delay in providing building plans and locations of electrical panels, and the like to emergency responders or an emergency service, could have potentially disastrous consequences.

### SUMMARY

In accordance with one embodiment described herein, a server associated with a building automation system of a building, determines an occurrence of an emergency in the building, based on detection of the emergency by one or more sensors distributed at respective locations in the building. The server transmits to a remote emergency service, over a communications medium, an alert of the detected emergency. In response, the server receives from the remote emergency service, an authorized login to temporarily transfer to the remote emergency service, control of the building automation system to respond to the detected emergency. In response to the authorized login, the server transfers control of the building automation system to the remote emergency service, and allows the remote emergency service to transmit a command to one or more devices in the building automation system. When the command is received by the one or more devices, it modifies or alters operation of the one or more devices. After the detected emergency has been resolved, the server disables the temporary transfer of control by the remote emergency service of the building automation system.

In accordance with an embodiment described herein, in response to the authorized login, the server transmits to the remote emergency service a depiction of a floor plan of the building displaying a current location of the emergency in the building. In an embodiment, the depiction of the floor plan of the building may display operational states of the one or more devices managed by the building automation system. In an embodiment, the depiction of the floor plan of the building may be different than a depiction of the floor plan seen by operators at the building automation system. In an embodiment, the server transmits to the remote emergency service a representation of controls for controlling the one or more devices in the building automation system. The controls are associated with the command directed to the one or more devices in the building automation system to enable the remote emergency service to activate the controls and transmit the command to control the one or more devices.

In accordance with an embodiment described herein, the server directly receives from the remote emergency service, the command directed to the one or more devices in the building automation system, and the server issues the command directed to the one or more devices, via the building automation system.

In accordance with an embodiment described herein, the server causes transmission of the command by the emergency service to the building automation system, as specified in the controls. The command is then issued by the building automation system to the one or more devices.

In accordance with an embodiment described herein, the server causes transmission of the command by the remote emergency service directly to the one or more devices, as specified in the controls, via a router.

In accordance with an embodiment described herein, the controls for controlling the one or more devices in the building automation system specify destinations of the command for at least one of sprinkler control devices, door-lock control devices, gas valve control devices, emergency lock control devices, lighting control devices, public-address system control devices, or heating-ventilation-air-conditioning system control devices.

In accordance with an embodiment described herein, a server, comprises:
at least one processor;
at least one memory, including computer program code, wherein the computer program code, when executed by operation of the at least one processor, causes an operation to be performed comprising:
determining, by a server, an emergency in a building, based on detection of the emergency by one or more sensors distributed at respective locations in the building;
transmitting, by the server, over a communications medium, to a remote emergency service, an alert of the detected emergency, in response to the detection of the emergency;
receiving, by the server, over a communications medium, from the remote emergency service, an authorized login to temporarily transfer to the remote emergency service control of a building automation system of the building to respond to the detected emergency;
causing, by the server via a communications medium, transmission of a command from the remote emergency service directed to one or more devices in the building automation system, wherein the command, when received by the one or more devices, modifies operation of the one or more devices;
causing, by the server via a communications medium, receipt of the command by the one or more devices in the building automation system, which was sent by the remote emergency service; and
disabling, by the server, the temporary transfer of control to the remote emergency service of the building automation system, after the detected emergency has been resolved.

In accordance with an embodiment described herein, the server further comprises:
the at least one memory, including computer program code, wherein the computer program code, when executed by operation of the at least one processor, causes an operation to be performed further comprising:
transmitting, by the server, over an internet communications medium, data specifying a depiction of a floor plan of the building displaying a current location of the emergency in the building in response to the receipt of the authorized login; and
transmitting, by the server, over the internet communications medium, a representation of controls for controlling the one or more devices in the building automation system, the controls associated with the command directed to the one or more devices in the building automation system, the controls representing the one or more devices to enable the remote emergency service to activate the controls and transmit the command to control the one or more devices.

In accordance with an embodiment described herein, the server further comprises:
wherein the depiction of the floor plan of the building displays operational states of the one or more devices managed by the building automation system for display to the remote emergency service.

In accordance with an embodiment described herein, the server further comprises:
wherein the controls include an internet address of the server, the server further comprising:
the at least one memory, including computer program code, wherein the computer program code, when executed by operation of the at least one processor, causes an operation to be performed further comprising:
receiving, by the server, over the internet communications medium, from the remote emergency service, the command directed to the one or more devices in the building automation system; and
issuing, by the server, the command directed to the one or more devices, via the building automation system.

In accordance with an embodiment described herein, the server further comprises:
wherein the controls include an internet address of the building automation system, the server further comprising:
the at least one memory, including computer program code, wherein the computer program code, when executed by operation of the at least one processor, causes an operation to be performed further comprising:
causing, by the server via the internet communications medium, transmission by the emergency service of the command directed to the one or more devices, to the building automation system specified in the controls, in response to the transmission of the alert and the receipt of the authorized login;
causing, by the server via the internet communications medium, receipt of the command by the one or more devices in the building automation system, which was sent by the remote emergency service to the building automation system, in response to the causing of the remote emergency service to transmit the command to the building automation system.

In accordance with an embodiment described herein, the server further comprises:
wherein the controls include an internet address to access a router, the server further comprising:
the at least one memory, including computer program code, wherein the computer program code, when executed by operation of the at least one processor, causes an operation to be performed further comprising:
causing, by the server via the internet communications medium, transmission by the remote emergency service of the command directed to the one or more devices, to the router accessible by the controls, in response to the transmission of the alert and the receipt of the authorized login;
causing, by the server via the internet communications medium, receipt of the command by the one or more devices in the building automation system, which was sent by the remote emergency service to the router, in response to the causing of the remote emergency service to transmit the command to the router.

In accordance with an embodiment described herein, the server further comprises:
wherein the controls for controlling the one or more devices in the building automation system specify internet addresses for at least one of sprinkler control devices, door-lock control devices, gas valve control devices, emergency lock control devices, lighting control devices, public-address system control devices, or heating-ventilation-air-conditioning system control devices.

In accordance with an embodiment described herein, a computer program product comprising computer executable program code recorded on a computer readable non-transitory storage medium, the computer executable program code comprises:
code for determining, by a server, an emergency in a building, based on detection of the emergency by one or more sensors distributed at respective locations in the building;
code for transmitting, by the server, over a communications medium, to a remote emergency service, an alert of the detected emergency, in response to the detection of the emergency;
code for receiving, by the server, over a communications medium, from the remote emergency service, an authorized login to temporarily transfer to the remote emergency service control of a building automation system of the building to respond to the detected emergency;
code for causing, by the server via a communications medium, transmission of a command from the remote emergency service directed to one or more devices in the building automation system, wherein the command, when received by the one or more devices, modifies operation of the one or more devices;
code for causing, by the server via a communications medium, receipt of the command by the one or more devices in the building automation system, which was sent by the remote emergency service; and
code for disabling, by the server, the temporary transfer of control to the remote emergency service of the building automation system, after the detected emergency has been resolved.

In accordance with an embodiment described herein, the computer program product further comprises:
code for transmitting, by the server, over an internet communications medium, data specifying a depiction of a floor plan of the building displaying a current location of the emergency in the building in response to the receipt of the authorized login; and
code for transmitting, by the server, over the internet communications medium, a representation of controls for controlling the one or more devices in the building automation system, the controls associated with the command directed to the one or more devices in the building automation system, the controls representing the one or more devices to enable the remote emergency service to activate the controls and transmit the command to control the one or more devices.

In accordance with an embodiment described herein, the computer program product further comprises:
wherein the depiction of the floor plan of the building displays operational states of the one or more devices managed by the building automation system for display to the remote emergency service.

In accordance with an embodiment described herein, the computer program product further comprises:
wherein the controls include an internet address of the server, the method further comprising:
code for receiving, by the server, over the internet communications medium, from the remote emergency service, the command directed to the one or more devices in the building automation system; and
code for issuing, by the server, the command directed to the one or more devices, via the building automation system.

In accordance with an embodiment described herein, the computer program product further comprises:
wherein the controls include an internet address of the building automation system, the method further comprising:
code for causing, by the server via the internet communications medium, transmission by the emergency service of the command directed to the one or more devices, to the building automation system specified in the controls, in response to the transmission of the alert and the receipt of the authorized login;
code for causing, by the server via the internet communications medium, receipt of the command by the one or more devices in the building automation system, which was sent by the remote emergency service to the building automation system, in response to the causing of the remote emergency service to transmit the command to the building automation system.

In accordance with an embodiment described herein, the computer program product further comprises:
wherein the controls include an internet address to access a router, the method further comprising:
code for causing, by the server via the internet communications medium, transmission by the remote emergency service of the command directed to the one or more devices, to the router accessible by the controls, in response to the transmission of the alert and the receipt of the authorized login;
code for causing, by the server via the internet communications medium, receipt of the command by the one or more devices in the building automation system, which was sent by the remote emergency service to the router, in response to the causing of the remote emergency service to transmit the command to the router.

In accordance with an embodiment described herein, the computer program product further comprises:
wherein the controls for controlling the one or more devices in the building automation system specify internet addresses for at least one of sprinkler control devices, door-lock control devices, gas valve control devices, emergency lock control devices, lighting control devices, public-address system control devices, or heating-ventilation-air-conditioning system control devices.

In accordance with an embodiment described herein, a method comprises:
determining, by a server, an emergency in a building, based on detection of the emergency by one or more sensors distributed at respective locations in the building;
transmitting, by the server, over a communications medium, to a remote emergency service, an alert of the detected emergency, in response to the detection of the emergency;
receiving, by the server, over a communications medium, from the remote emergency service, an authorized login to temporarily transfer to the remote emergency service control of a building automation system of the building to respond to the detected emergency;
causing, by the server via a communications medium, transmission of a command from the remote emergency service directed to one or more devices in the building automation system, wherein the command, when received by the one or more devices, modifies operation of the one or more devices;
causing, by the server via a communications medium, receipt of the command by the one or more devices in the building automation system, which was sent by the remote emergency service; and
disabling, by the server, the temporary transfer of control to the remote emergency service of the building automation system, after the detected emergency has been resolved.

In accordance with an embodiment described herein, the method further comprises:
transmitting, by the server, over an internet communications medium, data specifying a depiction of a floor plan of the building displaying a current location of the emergency in the building in response to the receipt of the authorized login; and
transmitting, by the server, over the internet communications medium, a representation of controls for controlling the one or more devices in the building automation system, the controls associated with the command directed to the one or more devices in the building automation system, the controls representing the one or more devices to enable the remote emergency service to activate the controls and transmit the command to control the one or more devices.

In accordance with an embodiment described herein, the method further comprises:
wherein the depiction of the floor plan of the building displays operational states of the one or more devices managed by the building automation system for display to the remote emergency service.

In accordance with an embodiment described herein, the method further comprises:
wherein the controls include an internet address of the server, the method further comprising:
receiving, by the server, over the internet communications medium, from the remote emergency service, the command directed to the one or more devices in the building automation system; and
issuing, by the server, the command directed to the one or more devices, via the building automation system.

In accordance with an embodiment described herein, the method further comprises:
wherein the controls include an internet address of the building automation system, the method further comprising:
causing, by the server via the internet communications medium, transmission by the emergency service of the command directed to the one or more devices, to the building automation system specified in the controls, in response to the transmission of the alert and the receipt of the authorized login;
causing, by the server via the internet communications medium, receipt of the command by the one or more devices in the building automation system, which was sent by the remote emergency service to the building automation system, in response to the causing of the remote emergency service to transmit the command to the building automation system;
causing, by the server via the internet communications medium, transmission by the remote emergency service of the command directed to the one or more devices, to the router accessible by the controls, in response to the transmission of the alert and the receipt of the authorized login; and
causing, by the server via the internet communications medium, receipt of the command by the one or more devices in the building automation system, which was sent by the remote emergency service to the router, in response to the causing of the remote emergency service to transmit the command to the router.

In accordance with an embodiment described herein, the server further comprises:
wherein the depiction of the floor plan of the building for display to the remote emergency service is different than a depiction of the floor plan of the building seen by operators at the building automation system.

The resulting method, apparatus, system, and computer program product integrates emergency detection systems into building automation systems to provide emergency response solutions to a remote emergency service by temporarily transferring control of the building control system to the remote emergency service so that building plans can be viewed and building equipment can be directly controlled by the remote emergency service.

### BRIEF DESCRIPTION OF THE DRAWINGS

A more detailed description of the disclosure, briefly summarized above, may be had by reference to various embodiments, some of which are illustrated in the appended drawings. While the appended drawings illustrate select embodiments of this disclosure, these drawings are not to be considered limiting of its scope, for the disclosure may admit to other equally effective embodiments.

FIG. 1 is an example network and functional block diagram of an emergency response handover system integrated into a building automation system, which temporarily transfers control of the building control system to an authorized remote emergency service to respond to a detected emergency, according to an embodiment of the disclosure.

FIG. 2A is a more detailed example network and functional block diagram of the emergency response handover system integrated into the building automation system of FIG. 1, illustrating the emergency response handover system directly receiving from the remote emergency service a command directed to one or more devices in the building automation system, and issuing the command to the devices, according to an embodiment of the disclosure.

FIG. 2B is a more detailed example network and functional block diagram of the emergency response handover system integrated into the building automation system of FIG. 1, illustrating causing transmission to the building automation system by the emergency service, of the command directed to the one or more devices, and causing, receipt of the command by the one or more devices from the building automation system, according to an embodiment of the disclosure.

FIG. 2C is a more detailed example network and functional block diagram of the emergency response handover system integrated into the building automation system of FIG. 1, illustrating causing transmission to the one or more devices by the remote emergency service, of the command directed to the one or more devices, according to an embodiment of the disclosure.

FIG. 2D is a more detailed example network and functional block diagram of the emergency response handover system integrated into the building automation system of FIG. 1, illustrating the emergency response handover system directly receiving from the remote emergency service a command directed to one or more devices in the building automation system, as in FIG. 2A, the emergency response handover system transferring the command to the building automation system, the building automation system transferring the command to a router, the router transmitting the command to the one or more devices, according to an embodiment of the disclosure.

FIG. 3 is an example depiction of the floor plan of the building in a web page document received from the emergency response handover system, displayed on a browser of the remote emergency service, displaying hyperlink control links to send commands to the one or more devices managed by the building automation system, according to an embodiment of the disclosure.

FIG. 4 is an example flow diagram of a method performed by the example emergency response handover system of FIG. 1, according to an embodiment of the disclosure.

Identical reference numerals have been used, where possible, to designate identical elements that are common to the figures. However, elements disclosed in one embodiment may be beneficially utilized on other embodiments without specific recitation.

### DETAILED DESCRIPTION

What is needed is a way to integrate emergency detection systems into building automation systems to provide emergency response solutions to emergency responders or remote emergency services by temporarily transferring control of the building control system to them so that building plans can be viewed and building equipment can be directly controlled by the emergency responders or remote emergency services.

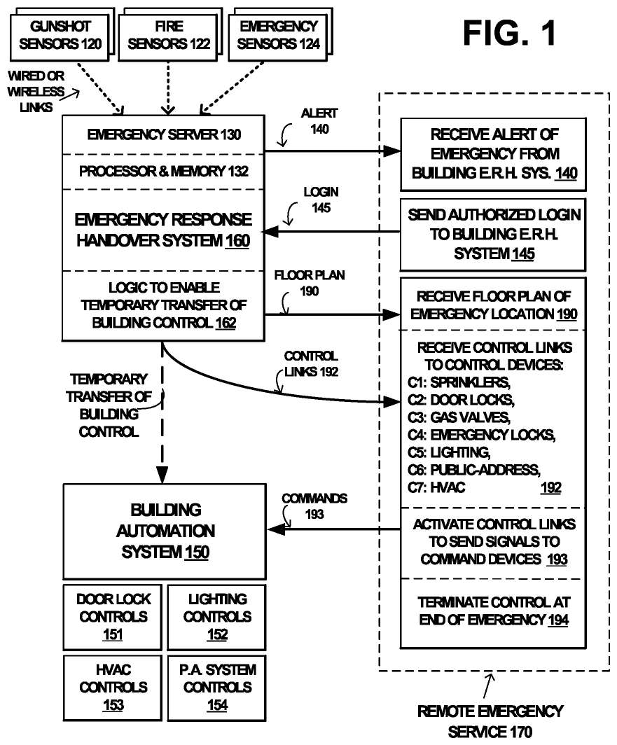

FIG. 1 is an example network and functional block diagram of an emergency response handover system 160 integrated into a building automation system 150 of a building, such as an office building, a school building, a theater, or the like. The emergency response handover system 160 may be computer program code residing in at least one memory 132, which when executed by operation of at least one processor in the emergency server 130, carries out the operations of the emergency response handover system 160. In another embodiment, the emergency response handover system 160 may be logic blocks implemented by computer hardware logic 162 in the emergency server 130, which may carry out the functions specified by the logic blocks. The emergency server 130 may reside in the same building as the building automation system 150 or it may be a cloud server accessed over a communications medium.

In the embodiment of FIG. 1, the emergency server 130 is connected by wired or wireless links to sensors, such as gunshot sensors 120, fire sensors 122, and emergency sensors 124. The emergency sensors 124 may include explosion sensors, hazardous materials release sensors, natural gas leak sensors, smoke sensors, plumbing failure or flooding sensors, power failure sensors, elevator failure sensors, and the like. The emergency response handover system 160 in the emergency server 130 determines that an emergency has occurred in the building, based on detection of the emergency by one or more of the sensors 120, 122, and 124 distributed at respective locations in the building.

In response to the detection of the emergency, the emergency response handover system 160 transmits an alert 140 of the detected emergency, over a communications medium, such as the internet or a public safety radio band, to a remote emergency service 170. Example remote emergency services 170 include law enforcement, firefighting, hazardous materials response, emergency medical services, technical rescue, and security services.

In response to the transmission of the alert 140, the emergency response handover system 160 receives over a communications medium, such as the internet, from the remote emergency service 170, an authorized login 145 to temporarily transfer to the remote emergency service 170, control of the building automation system 150 of the building, to respond to the detected emergency. Authorization of the remote emergency service 170 may have been previously arranged by the management authority of the building.

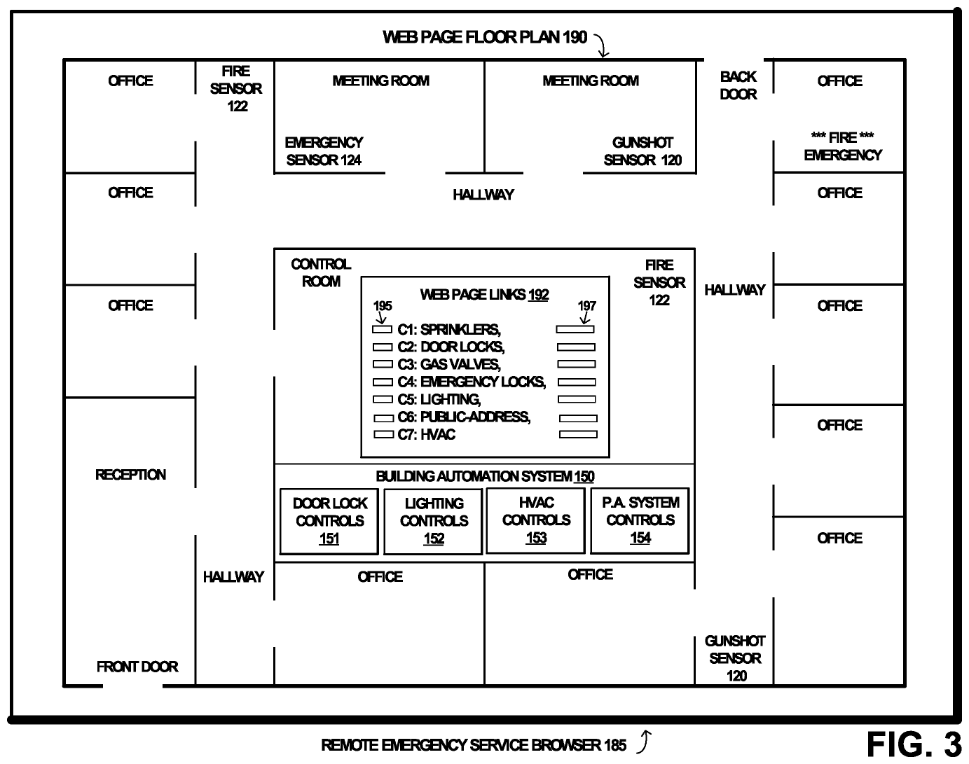

In response to the receipt of the authorized login 145, the emergency response handover system 160 transmits over a communications medium, such as the internet, to the remote emergency service 170, a depiction of a floor plan 190 of the building displaying a current location of the emergency in the building. In an example embodiment, the depiction may be a web page document that depicts the floor plan 190 of the building, displaying a current location of the emergency, as shown in FIG. 3. Since the location of the emergency may be moving within the building, consecutive web page documents may be transmitted with consecutive depictions of the floor plan 190 to dynamically present changes in the location and extent of the emergency. The web page document depicting of the floor plan 190 of the building, may display information and associated operational states of the one or more devices 151-154 managed by the building automation system 150, for display to the remote emergency service 170. In embodiments, the depiction of the floor plan 190 of the building, for display to the remote emergency service 170, may be different than a depiction of the floor plan of the building seen by operators at the building automation system 150. Example devices 151-154 managed by the building automation system 150 may include sprinkler control devices, door-lock control devices, gas valve control devices, emergency lock control devices, lighting control devices, public-address system control devices, and heating-ventilation-air-conditioning system control devices.

In response to the receipt of the authorized login 145, the emergency response handover system 160 transmits to the remote emergency service 170 over the internet communications medium, a representation of controls 192 for controlling the one or more devices 151-154 in the building automation system 150. The controls 192 are associated with a command 193 directed to the one or more devices 151-154 in the building automation system 150. The remote emergency service 170 may activate the controls 192 and transmit the command 193 to control the one or more devices 151-154. The hyperlink controls 192, identified as C1, C2, . . . C7, may be icons 195 displayed in the browser 185 of the emergency service browser 185 (FIG. 3), which may be selected to activate the corresponding command 193. In response, the one or more devices 151-154 may reply to the remote emergency service 170 with an acknowledgement that the command has been received. The one or more devices 151-154 may also transmit to the remote emergency service 170 a status of the device as to whether the command has been executed and/or a status of the device after the command has been executed. The status of the device may be displayed in a window 197 in the browser 185 of the remote service 170 (FIG. 3). In an example embodiment, the controls 192 are control links or hyperlinks that may be unique web addresses, such as https://www.ERH.com/Door-Lock-Controls?Front-Door=Unlock. This example unique web address is a Uniform Resource Locator (URL) that includes the internet address of the emergency response handover system 160 (abbreviated “ERH.com”), the path to the “door lock controls” device 151, and parameters including a key part “?Front-Door”, and the command value 193 “=Unlock”, specifying a specific command to unlock the front door of the building.

In an example embodiment, the controls 192 are control links that may have an alternate form, for example a POST request method supported by HTTP, which requests that a web server accepts the data enclosed in the body of the request message. An example is:
POST https://www.BMS.com/device/{device_id}/command” DATA<json>,
For example:
POST https://www.BMS.com/device/E453F2282A2B213C123B23DF23EA34B34C/command
DATA {“type”:“set”,“param”:“light_level_percent”,“value”:75}

Another example POST request embodiment of the control links may be:
POST https://www.BMS.com/zone/{ zone_id}/command
DATA <json>,
For example:
POST https://www.BMS.com/zone/FG45223C12F23A34C82A2B213C23EA34B78C/command
DATA { “type”:“set”,“param”:“temperature_celsius ”,“value”:24}

In response to the receipt of the authorized login 145, the emergency response handover system 160 causes the remote emergency service 170 to transmit the command 193 directed to one or more of the devices 151-154 in the building automation system 150. The command 193, when received by the one or more devices 151-154, modifies or alters operation of the one or more devices 151-154. Continuing with the preceding example, the remote emergency service 170 activates the control 192 by selecting the URL that includes the internet address of the emergency response handover system 160 (abbreviated “ERH.com”), the path to the “door lock controls” device 151, and the parameters specifying the specific command to unlock the front door of the building. The remote emergency service 170 transmits the URL over the internet to the emergency response handover system 160. The emergency response handover system 160 then issues the command 193 to the door lock controls device 151, by passing to the building automation system 150 the parameters specifying the specific command 193 to unlock the front door of the building. In response, the door lock controls device 151, carries out the specific command to unlock the front door of the building.

In an example embodiment, the emergency sensors 120, 122, 124 may be attached to the building automation system 150. In this embodiment, control has been transferred from the building automation system 150 to the remote service 170 and yet the sensors 120, 122, 124 may continuously provide updates 147 to the remote service 170 browser 185 (FIG. 3) in order to keep the emergency service informed of current situations. The continuously provided updates 147 from the sensors 120, 122, 124 pass through the building automation system 150 and through the handover system 160, and are transmitted to the remote service 170, while also sending control commands 193.

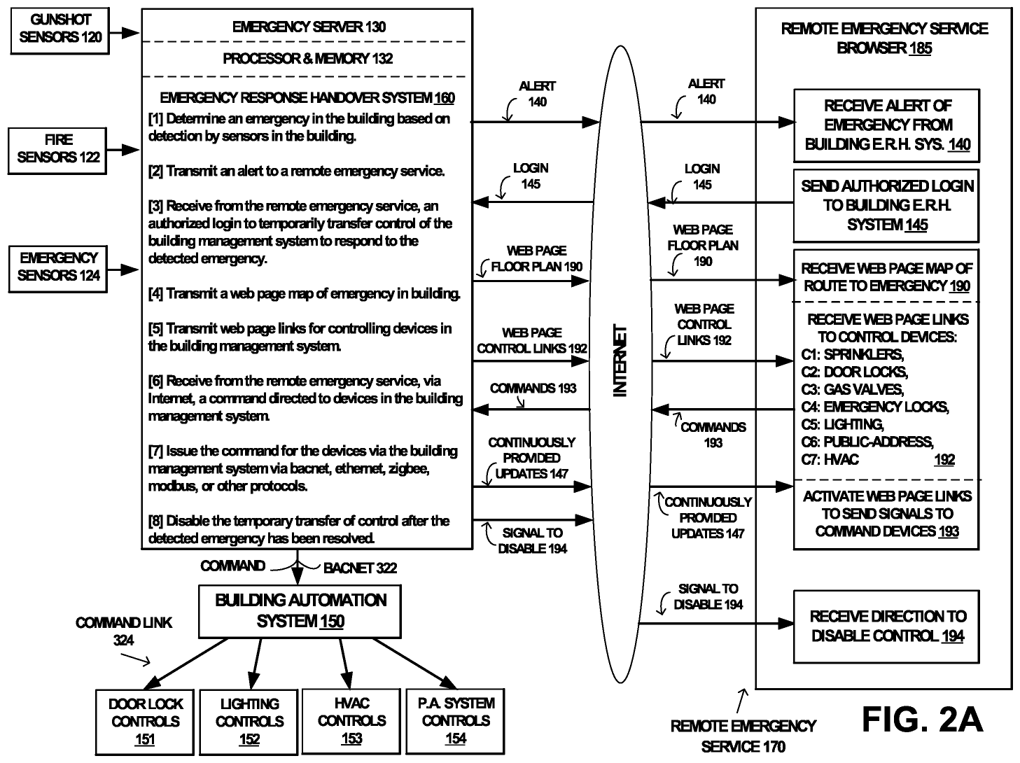

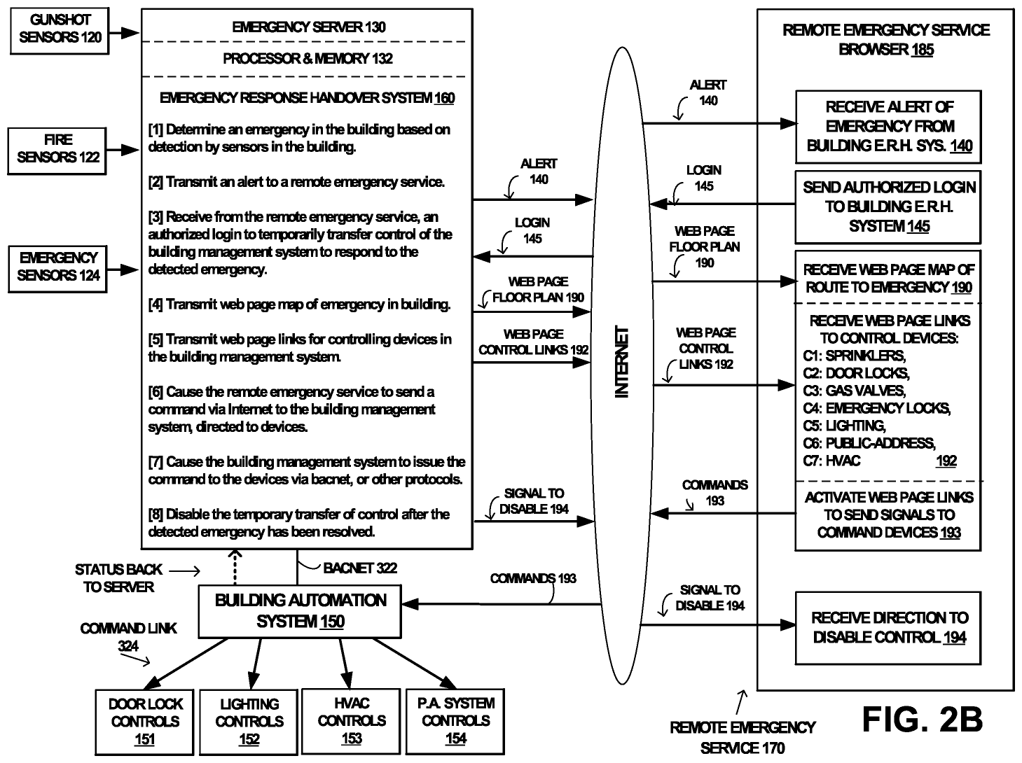

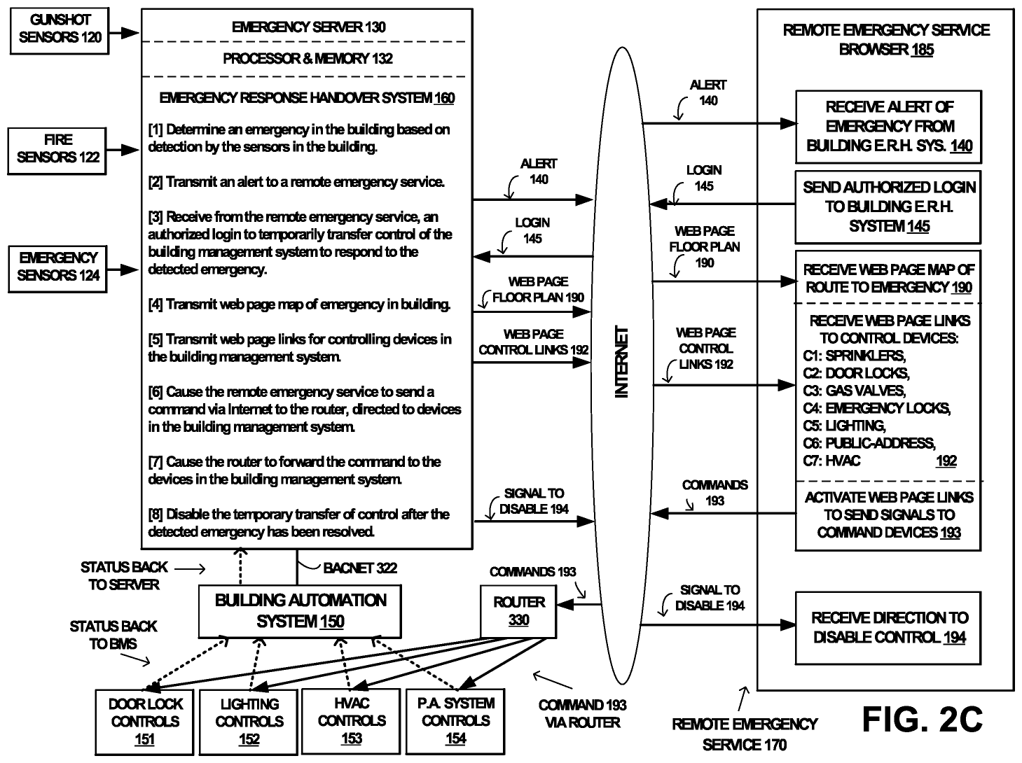

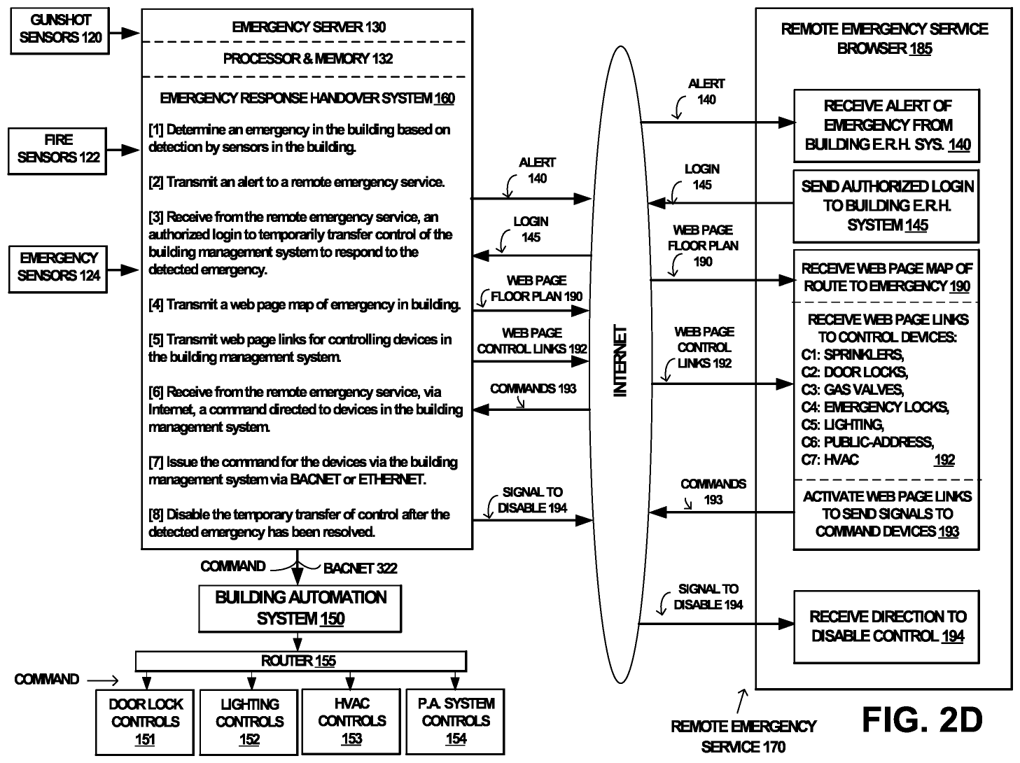

FIG. 2A is a more detailed example network and functional block diagram of the emergency response handover system 160 integrated into the building automation system 150 of FIG. 1, illustrating the emergency response handover system 160 receiving from the remote emergency service 170 the command 193 directed to one or more devices 151-154 in the building automation system 150. Then the emergency response handover system 160 issues the command 193 to the devices 151-154, according to an embodiment of the disclosure. The embodiment of the emergency response handover system 160 in FIG. 2A may perform the functions in the following logic blocks:

[1] Determine an emergency in the building based on detection by sensors 120, 122, and/or 124. in the building.

[2] Transmit an alert 140 to a remote emergency service 170.

[3] Receive from the remote emergency service 170, an authorized login 145 to temporarily transfer control of the building automation system 150 to respond to the detected emergency.

[4] Transmit a web page map 190 of emergency in building.

[5] Transmit web page links 192 for controlling devices 151-154 in the building automation system 150.

[6] Receive from the remote emergency service 170, via Internet, a command 193 directed to devices 151-154 in the building automation system 150.

[7] Issue at 322 the command 193 to the building automation system 150, which transfers the command at 324 to the devices 151-154 via bacnet, ethernet, zigbee, modbus, or other protocols.

[8] Disable 194 the temporary transfer of control after the detected emergency has been resolved.

The example hyperlink control links 192 sent by the emergency response handover system 160 to the remote emergency service 170 in FIG. 2A, for controlling the one or more devices 151-154 in the building automation system 150, are shown in Table 1:

TABLE 1
Example Hyperlink Control Links 192

| Control | Destination | BMS Control Device | Path | Command 193 |
|---|---|---|---|---|
| C1 | ERH.com/ | Sprinklers | ?Meeting-room | =Turn-Off |
| C2 | ERH.com/ | Door-Lock-Controls | ?Front-Door | =Unlock |
| C3 | ERH.com/ | Gas-Valves | ?Main-Valve | =Turn-Off |
| C4 | ERH.com/ | Emergency-Locks | ?Control Room | =Unlock |
| C5 | ERH.com/ | Lighting | ?Main-Lighting | =Turn-On |
| C6 | ERH.com/ | Public-Address | ?Hallways | =Turn-On |
| C7 | ERH.com/ | HVAC | ?Fans | =Turn-Off |

FIG. 3 is an example illustration of the browser 185 of the remote emergency service 170, displaying an example depiction of the floor plan 190 of the building in the web page document received from the emergency response handover system 169. The depiction of the floor plan 190 includes the hyperlink controls 192, identified as C1, C2, . . . C7, for controlling the one or more devices 151-154 in the building automation system 150. The depiction of the hyperlink controls 192, identified as C1, C2, . . . C7 may be as icons 195 displayed in the browser 185 of the emergency service browser 185, which may be selected to activate the corresponding command 193. The hyperlink controls 192 are associated with the command 193 directed to the one or more devices 151-154 in the building automation system 150. The remote emergency service 170 may activate the hyperlink controls 192 displayed in the browser 185 and transmit the command 193 to control the one or more devices 151-154. The example depiction of the floor plan 190 may also display operational states of the one or more devices 151-154 managed by the building automation system 150, and the locations of the sensors 120, 122, and 124.

The emergency response handover system 160, which has the destination internet address “ERH.com/”, receives from the remote emergency service 170 the command 193 for the one or more devices 151-154 in the building automation system 150. The emergency response handover system 160 issues the command to the devices 151-154.

The remote emergency service 170 may activate the controls 192 and transmit the command 193 to control the one or more devices 151-154. In response, the one or more devices 151-154 may reply to the remote emergency service 170 with an acknowledgement that the command has been received. The one or more devices 151-154 may also transmit to the remote emergency service 170 a status of the device as to whether the command has been executed and/or a status of the device after the command has been executed. The status of the device may be displayed in a window 197 on the browser 185 of the remote service 170.

After the detected emergency has been resolved, the emergency response handover system 160 disables the temporary transfer of control to the remote emergency service 170 of the building automation system 150.

FIG. 2B is a more detailed example network and functional block diagram of the emergency response handover system 160 integrated into the building automation system 150 of FIG. 1, illustrating the building automation system 150 directly receiving from the remote emergency service 170, a command 193 directed to one or more devices 151-154 in the building automation system 150. The building automation system 150 issues the command to the devices 151-154, according to an embodiment of the disclosure. The embodiment of the emergency response handover system 160 in FIG. 2B may perform the functions in the following logic blocks:

[1] Determine an emergency in the building based on detection by sensors 120, 122, and/or 124. in the building.

[2] Transmit an alert 140 to a remote emergency service 170.

[3] Receive from the remote emergency service 170, an authorized login 145 to temporarily transfer control of the building automation system 150 to respond to the detected emergency.

[4] Transmit a web page map 190 of emergency in building.

[5] Transmit web page links 192 for controlling devices 151-154 in the building automation system 150.

[6] Cause the remote emergency service 170 to send a command 193 directly, via Internet, to the building automation system 150, directed to devices.

[7] Cause the building automation system 150 to issue the command 193 at 324 to the devices via bacnet, ethernet, zigbee, modbus, or other protocols.

[8] Disable 194 the temporary transfer of control after the detected emergency has been resolved.

The example hyperlink control links 192 sent by the emergency response handover system 160 to the remote emergency service 170 in FIG. 2B, for controlling the one or more devices 151-154 in the building automation system 150, are shown in Table 2:

TABLE 2
Example Hyperlink Control Links 192

| Control | Destination | BMS Control Device | Path | Command 193 |
|---|---|---|---|---|
| C1 | BMS.com/ | Sprinklers | ?Meeting-room | =Turn-Off |
| C2 | BMS.com/ | Door-Lock-Controls | ?Front-Door | =Unlock |
| C3 | BMS.com/ | Gas-Valves | ?Main-Valve | =Turn-Off |
| C4 | BMS.com/ | Emergency-Locks | ?Control Room | =Unlock |
| C5 | BMS.com/ | Lighting | ?Main-Lighting | =Turn-On |
| C6 | BMS.com/ | Public-Address | ?Hallways | =Turn-On |
| C7 | BMS.com/ | HVAC | ?Fans | =Turn-Off |

The building automation system 150, which has the destination internet address “BMS.com/”, receives from the remote emergency service 170 the command 193 for the one or more devices 151-154 in the building automation system 150. The building automation system 150 issues the command 193 to the devices 151-154.

FIG. 2C is a more detailed example network and functional block diagram of the emergency response handover system 160 integrated into the building automation system 150 of FIG. 1, illustrating the emergency response handover system 160 causing transmission of the command 193 by the remote emergency service 170 directly to the one or more devices 151-154, as specified in the controls 192, via a router 330. When the command 193 is received by the one or more devices 151-154, they execute the command. The embodiment of the emergency response handover system 160 in FIG. 2C may perform the functions in the following logic blocks:

[1] Determine an emergency in the building based on detection by sensors 120, 122, and/or 124. in the building.

[2] Transmit an alert 140 to a remote emergency service 170.

[3] Receive from the remote emergency service 170, an authorized login 145 to temporarily transfer control of the building automation system 150 to respond to the detected emergency.

[4] Transmit a web page map 190 of emergency in building.

[5] Transmit web page links 192 for controlling devices 151-154 in the building automation system 150.

[6] Cause the remote emergency service to send a command via Internet to the router, directed to devices in the building automation system.

[7] Cause the router to forward the command to the devices in the building automation system.

[8] Disable 194 the temporary transfer of control after the detected emergency has been resolved.

The example hyperlink control links 192 are sent by the emergency response handover system 160 to the remote emergency service 170 in FIG. 2C, for controlling the one or more devices 151-154 in the building automation system 150, are shown in Table 3:

TABLE 3
Example Hyperlink Control Links 192

| Control | Destination | Path | Command 193 |
|---|---|---|---|
| C1 | Sprinklers.com/ | ?Meeting-room | =Turn-Off |
| C2 | Door-Lock-Controls.com/ | ?Front-Door | =Unlock |
| C3 | Gas-Valves.com/ | ?Main-Valve | =Turn-Off |
| C4 | Emergency-Locks.com/ | ?Control Room | =Unlock |
| C5 | Lighting.com/ | ?Main-Lighting | =Turn-On |
| C6 | Public-Address.com/ | ?Hallways | =Turn-On |
| C7 | HVAC.com/ | ?Fans | =Turn-Off |

The individual one of the one or more devices 151-154, which has the respective destination internet address, such as “Sprinklers.com/”, etc., receives from the remote emergency service 170 the command 193 for the respective one of the devices 151-154 in the building automation system 150, and the respective one of the devices 151-154 executes the command,

FIG. 2D is a more detailed example network and functional block diagram of the emergency response handover system integrated into the building automation system of FIG. 1, illustrating the emergency response handover system 160 directly receiving from the remote emergency service 170 a command 193 directed to one or more devices 151, 152, 153, and/or 154 in the building automation system, as in FIG. 2A, the emergency response handover system 160 transferring the command to the building automation system 150, the building automation system 150 transferring the command to a router 155, the router 155 transmitting the command to the one or more devices 151, 152, 153, and/or 154, according to an embodiment of the disclosure.

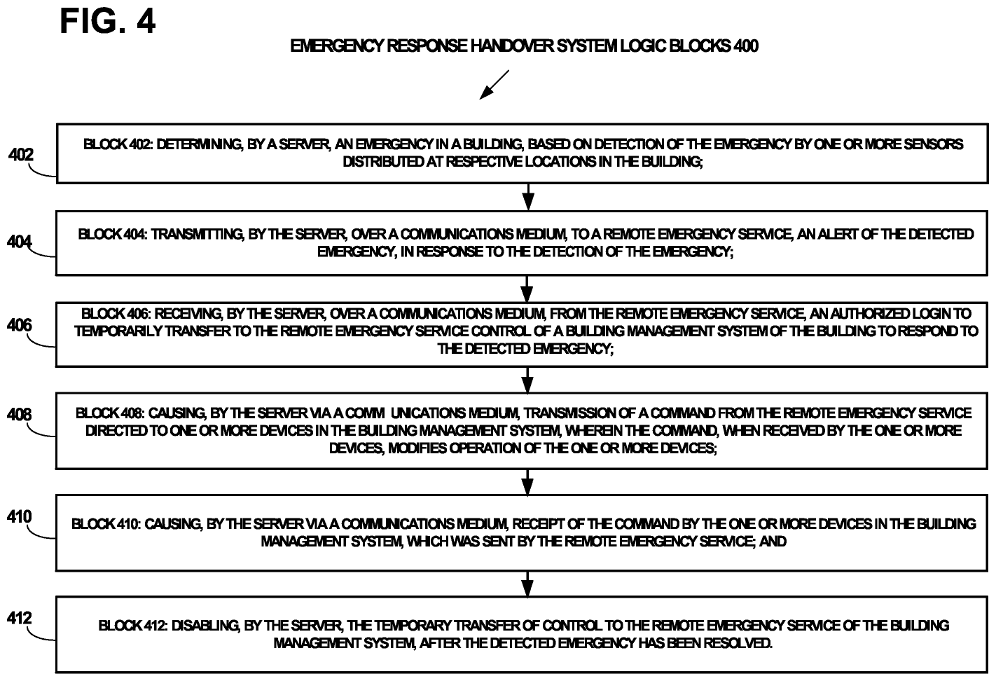

FIG. 4 is an example flow diagram 400 of a method performed by the emergency response handover system 160 in the emergency server 130 of FIG. 1, according to an embodiment of the disclosure. The logic blocks of the flow diagram 400 may be implemented by computer program instructions stored in the memory 132 and executed by the processor in the emergency server 130 of FIG. 1. Alternately, the logic blocks of the flow diagram 400 may also be implemented by computer hardware logic 162 in the emergency server 130 of FIG. 1, which can carry out the functions specified by the logic blocks.

The method performed by the example central controller 100 for minimizing crosstalk, comprises the following logic blocks:

Block 402: determining, by a server, an emergency in a building, based on detection of the emergency by one or more sensors distributed at respective locations in the building;

Block 404: transmitting, by the server, over a communications medium, to a remote emergency service, an alert of the detected emergency, in response to the detection of the emergency;

Block 406: receiving, by the server, over a communications medium, from the remote emergency service, an authorized login to temporarily transfer to the remote emergency service control of a building automation system of the building to respond to the detected emergency;

Block 408: causing, by the server via a communications medium, transmission of a command from the remote emergency service directed to one or more devices in the building automation system, wherein the command, when received by the one or more devices, modifies operation of the one or more devices;

Block 410: causing, by the server via a communications medium, receipt of the command by the one or more devices in the building automation system, which was sent by the remote emergency service; and

Block 412: disabling, by the server, the temporary transfer of control to the remote emergency service of the building automation system, after the detected emergency has been resolved.

Current building automation emergency response control handoff systems are not designed to temporarily transfer to a remote emergency service, control of the building automation system in response to detecting an emergency by one or more building sensors. This is a technical problem. In an exemplary embodiment of a building automation response control handoff system, a processor is instructed to determine an emergency based on detection of the emergency by building sensors, transmit an alert of the emergency to a remote emergency service, and receive an authorized login to temporarily transfer control of the building automation system to the remote service. The processor may be instructed to transmit a command from the remote service to devices in the building automation system, wherein the command modifies operation of the devices when received by them. The processor may disable the temporary transfer of control to the remote service after the detected emergency has been resolved. At least this foregoing combination of features comprises a building automation emergency response control handoff system that serves as a technical solution to the foregoing technical problem. This technical solution is not routine and is unconventional. This technical solution is a practical application of a building automation emergency response control handoff system that solves the foregoing technical problem and constitutes an improvement in the technical field of building-automation-system design, at least by facilitating temporary transfer to a remote emergency service control of the building automation system in response to detecting an emergency by one or more building sensors.

In the preceding, reference is made to various embodiments. However, the scope of the present disclosure is not limited to the specific described embodiments. Instead, any combination of the described features and elements, whether related to different embodiments or not, is contemplated to implement and practice contemplated embodiments. Furthermore, although embodiments may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

The various embodiments disclosed herein may be implemented as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “component”, “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a non-transitory computer-readable medium. A non-transitory computer-readable medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer-readable medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages. Moreover, such computer program code can execute using a single computer system or by multiple computer systems communicating with one another (e.g., using a local area network (LAN), wide area network (WAN), the Internet, etc.). While various features in the preceding are described with reference to flowchart illustrations and/or block diagrams, a person of ordinary skill in the art will understand that each block of the flowchart illustrations and/or block diagrams, as well as combinations of blocks in the flowchart illustrations and/or block diagrams, can be implemented by computer logic (e.g., computer program instructions, hardware logic, a combination of the two, etc.). Generally, computer program instructions may be provided to a processor(s) of a general-purpose computer, special-purpose computer, or other programmable data processing apparatus. Moreover, the execution of such computer program instructions using the processor(s) produces a machine that can carry out a function(s) or act(s) specified in the flowchart and/or block diagram block or blocks.

The flowchart and block diagrams in the Figures illustrate the architecture, functionality and/or operation of possible implementations of various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that the above description is intended to be illustrative, and not restrictive. Many other implementation examples are apparent upon reading and understanding the above description. Although the disclosure describes specific examples, it is recognized that the systems and methods of the disclosure are not limited to the examples described herein but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

What is claimed is:

1. A server, comprising:
at least one processor;
at least one memory, including computer program code, wherein the computer program code, when executed by operation of the at least one processor, causes an operation to be performed comprising:
determining, by a server, an emergency in a building, based on detection of the emergency by one or more sensors distributed at respective locations in the building;
transmitting, by the server, over a communications medium, to a remote emergency service, an alert of the detected emergency, in response to the detection of the emergency;
receiving, by the server, over a communications medium, from the remote emergency service, an authorized login to temporarily transfer to the remote emergency service control of a building automation system of the building to respond to the detected emergency;
causing, by the server via a communications medium, transmission of a command from the remote emergency service directed to one or more devices in the building automation system, wherein the command, when received by the one or more devices, modifies operation of the one or more devices;
causing, by the server via a communications medium, receipt of the command by the one or more devices in the building automation system, which was sent by the remote emergency service; and
disabling, by the server, the temporary transfer of control to the remote emergency service of the building automation system, after the detected emergency has been resolved.

2. The server of claim 1, further comprising:
the at least one memory, including computer program code, wherein the computer program code, when executed by operation of the at least one processor, causes an operation to be performed further comprising:
transmitting, by the server, over an internet communications medium, data specifying a depiction of a floor plan of the building displaying a current location of the emergency in the building in response to the receipt of the authorized login; and
transmitting, by the server, over the internet communications medium, a representation of controls for controlling the one or more devices in the building automation system, the controls associated with the command directed to the one or more devices in the building automation system, the controls representing the one or more devices to enable the remote emergency service to activate the controls and transmit the command to control the one or more devices.

3. The server of claim 2, wherein the depiction of the floor plan of the building displays operational states of the one or more devices managed by the building automation system for display to the remote emergency service.

4. The server of claim 2, wherein the controls include an internet address of the server, the server further comprising:
the at least one memory, including computer program code, wherein the computer program code, when executed by operation of the at least one processor, causes an operation to be performed further comprising:
receiving, by the server, over the internet communications medium, from the remote emergency service, the command directed to the one or more devices in the building automation system; and
issuing, by the server, the command directed to the one or more devices, via the building automation system.

5. The server of claim 2, wherein the controls include an internet address of the building automation system, the server further comprising:
the at least one memory, including computer program code, wherein the computer program code, when executed by operation of the at least one processor, causes an operation to be performed further comprising:
causing, by the server via the internet communications medium, transmission by the emergency service of the command directed to the one or more devices, to the building automation system specified in the controls, in response to the transmission of the alert and the receipt of the authorized login;
causing, by the server via the internet communications medium, receipt of the command by the one or more devices in the building automation system, which was sent by the remote emergency service to the building automation system, in response to the causing of the remote emergency service to transmit the command to the building automation system.

6. The server of claim 2, wherein the controls include an internet address to access a router, the server further comprising:
the at least one memory, including computer program code, wherein the computer program code, when executed by operation of the at least one processor, causes an operation to be performed further comprising:
causing, by the server via the internet communications medium, transmission by the remote emergency service of the command directed to the one or more devices, to the router accessible by the controls, in response to the transmission of the alert and the receipt of the authorized login;
causing, by the server via the internet communications medium, receipt of the command by the one or more devices in the building automation system, which was sent by the remote emergency service to the router, in response to the causing of the remote emergency service to transmit the command to the router.

7. The server of claim 2, wherein the controls for controlling the one or more devices in the building automation system specify internet addresses for at least one of sprinkler control devices, door-lock control devices, gas valve control devices, emergency lock control devices, lighting control devices, public-address system control devices, or heating-ventilation-air-conditioning system control devices.

8. A computer program product comprising computer executable program code recorded on a computer readable non-transitory storage medium, the computer executable program code comprising:
code for determining, by a server, an emergency in a building, based on detection of the emergency by one or more sensors distributed at respective locations in the building;
code for transmitting, by the server, over a communications medium, to a remote emergency service, an alert of the detected emergency, in response to the detection of the emergency;
code for receiving, by the server, over a communications medium, from the remote emergency service, an authorized login to temporarily transfer to the remote emergency service control of a building automation system of the building to respond to the detected emergency;
code for causing, by the server via a communications medium, transmission of a command from the remote emergency service directed to one or more devices in the building automation system, wherein the command, when received by the one or more devices, modifies operation of the one or more devices;
code for causing, by the server via a communications medium, receipt of the command by the one or more devices in the building automation system, which was sent by the remote emergency service; and
code for disabling, by the server, the temporary transfer of control to the remote emergency service of the building automation system, after the detected emergency has been resolved.

9. The computer program product of claim 8, further comprising:
code for transmitting, by the server, over an internet communications medium, data specifying a depiction of a floor plan of the building displaying a current location of the emergency in the building in response to the receipt of the authorized login; and
code for transmitting, by the server, over the internet communications medium, a representation of controls for controlling the one or more devices in the building automation system, the controls associated with the command directed to the one or more devices in the building automation system, the controls representing the one or more devices to enable the remote emergency service to activate the controls and transmit the command to control the one or more devices.

10. The computer program product of claim 9, wherein the depiction of the floor plan of the building displays operational states of the one or more devices managed by the building automation system for display to the remote emergency service.

11. The computer program product of claim 9, wherein the controls include an internet address of the server, the method further comprising:
code for receiving, by the server, over the internet communications medium, from the remote emergency service, the command directed to the one or more devices in the building automation system; and
code for issuing, by the server, the command directed to the one or more devices, via the building automation system.

12. The computer program product of claim 9, wherein the controls include an internet address of the building automation system, the method further comprising:
code for causing, by the server via the internet communications medium, transmission by the emergency service of the command directed to the one or more devices, to the building automation system specified in the controls, in response to the transmission of the alert and the receipt of the authorized login;
code for causing, by the server via the internet communications medium, receipt of the command by the one or more devices in the building automation system, which was sent by the remote emergency service to the building automation system, in response to the causing of the remote emergency service to transmit the command to the building automation system.

13. The computer program product of claim 9, wherein the controls include an internet address to access a router, the method further comprising:
code for causing, by the server via the internet communications medium, transmission by the remote emergency service of the command directed to the one or more devices, to the router accessible by the controls, in response to the transmission of the alert and the receipt of the authorized login;
code for causing, by the server via the internet communications medium, receipt of the command by the one or more devices in the building automation system, which was sent by the remote emergency service to the router, in response to the causing of the remote emergency service to transmit the command to the router.

14. The computer program product of claim 9, wherein the controls for controlling the one or more devices in the building automation system specify internet addresses for at least one of sprinkler control devices, door-lock control devices, gas valve control devices, emergency lock control devices, lighting control devices, public-address system control devices, or heating-ventilation-air-conditioning system control devices.

15. A method, comprising:
determining, by a server, an emergency in a building, based on detection of the emergency by one or more sensors distributed at respective locations in the building;
transmitting, by the server, over a communications medium, to a remote emergency service, an alert of the detected emergency, in response to the detection of the emergency;
receiving, by the server, over a communications medium, from the remote emergency service, an authorized login to temporarily transfer to the remote emergency service control of a building automation system of the building to respond to the detected emergency;
causing, by the server via a communications medium, transmission of a command from the remote emergency service directed to one or more devices in the building automation system, wherein the command, when received by the one or more devices, modifies operation of the one or more devices;
causing, by the server via a communications medium, receipt of the command by the one or more devices in the building automation system, which was sent by the remote emergency service; and
disabling, by the server, the temporary transfer of control to the remote emergency service of the building automation system, after the detected emergency has been resolved.

16. The method of claim 15, further comprising:
transmitting, by the server, over an internet communications medium, data specifying a depiction of a floor plan of the building displaying a current location of the emergency in the building in response to the receipt of the authorized login; and
transmitting, by the server, over the internet communications medium, a representation of controls for controlling the one or more devices in the building automation system, the controls associated with the command directed to the one or more devices in the building automation system, the controls representing the one or more devices to enable the remote emergency service to activate the controls and transmit the command to control the one or more devices.

17. The method of claim 16, wherein the depiction of the floor plan of the building displays operational states of the one or more devices managed by the building automation system for display to the remote emergency service.

18. The method of claim 16, wherein the controls include an internet address of the server, the method further comprising:
receiving, by the server, over the internet communications medium, from the remote emergency service, the command directed to the one or more devices in the building automation system; and
issuing, by the server, the command directed to the one or more devices, via the building automation system.

19. The method of claim 16, wherein the controls include an internet address of the building automation system, the method further comprising:
causing, by the server via the internet communications medium, transmission by the emergency service of the command directed to the one or more devices, to the building automation system specified in the controls, in response to the transmission of the alert and the receipt of the authorized login;
causing, by the server via the internet communications medium, receipt of the command by the one or more devices in the building automation system, which was sent by the remote emergency service to the building automation system, in response to the causing of the remote emergency service to transmit the command to the building automation system;
causing, by the server via the internet communications medium, transmission by the remote emergency service of the command directed to the one or more devices, to the router accessible by the controls, in response to the transmission of the alert and the receipt of the authorized login; and
causing, by the server via the internet communications medium, receipt of the command by the one or more devices in the building automation system, which was sent by the remote emergency service to the router, in response to the causing of the remote emergency service to transmit the command to the router.

20. The server of claim 2, wherein the depiction of the floor plan of the building for display to the remote emergency service is different than a depiction of the floor plan of the building seen by operators at the building automation system.
